(19) United States
(12) Patent Application Publication
(10) Pub. No.: US 2006/0237411 A1
(43) Pub. Date: Oct. 26, 2006

(54) Gas metal arc welding methods and apparatus

(76) Inventors: Patricio F. Mendez, Golden, CO (US); Erik Soderstrom, Golden, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/410,271

(22) Filed: Apr. 24, 2006

Related U.S. Application Data
(60) Provisional application No. 60/673,917, filed on Apr. 22, 2005.

(51) Int. Cl. B23K 9/173

(52) U.S. Cl. 219/137 R; 219/137.61

(57) ABSTRACT

Methods and apparatus for gas metal arc welding are provided. The methods of the invention allow production of high quality welds using shielding gas atmospheres having at least 30% carbon dioxide and electrode diameters less than 1.6 mm. The metal transfer mode is not short-circuit transfer. The invention also provides welding torch contact tips having a localized contact region.

### CROSS REFERENCE TO RELATED APPLICATIONS

This application claims the benefit of U.S. Provisional Application 60/673,917, filed Apr. 22, 2005, which is hereby incorporated by reference to the extent not inconsistent with the disclosure herein.

### BACKGROUND OF THE INVENTION

In Gas Metal Arc Welding (GMAW), also sometimes known as Metal Inert Gas (MIG) welding, an electric arc is established between the workpiece and a consumable bare wire electrode. The arc continuously melts the wire as it is fed to the weld puddle. The weld metal is shielded from the atmosphere by a flow of a gas or a gas mixture, often an inert gas mixture. The welding process usually operates with the wire electrode positive, acting as the anode. Welding currents from 50 amperes up to more than 600 amperes are commonly used at welding voltages of 15V to 40V. The GMAW process is applicable to the welding of all commercially important metals such as steel, aluminum, stainless steel, copper and several others.

The mode of metal transfer from the consumable wire electrode to the workpiece is dependent upon the operating parameters such as welding current, voltage, wire size, wire speed, electrode extension and the protective shielding gas composition. FIG. 1 summarizes the three principal metal transfer modes and their strengths and weaknesses. Spray transfer is characterized by a high transfer frequency of small droplets, with the droplet diameter being less than the electrode diameter. In drop spray, the diameter is slightly smaller than the electrode. In streaming spray, shown in FIG. 1, the droplets are significantly smaller than the electrode. Small droplets impinge on the weld pool with minimum “splashing,” therefore the weld seam is very clean and uniform. Because of their small size, these droplets offer little heat transfer resistance, thus they experience less overheating, less evaporation, and less fume generation. This transfer mode can be used at high currents, and it is adequate for high productivity situations. For steel welds, spray transfer is typically conducted with argon-base shielding gases.

Globular transfer is characterized by large droplets, with the droplet size being larger than the wire diameter. In general, larger droplets do not allow for the same weld quality as spray transfer. The large droplets disrupt the weld pool upon impinging, generating spatter and an overall poor weld seam appearance. Also such large droplets overheat more than in spray transfer, thus generating more fumes. However, globular transfer allows for the use of a much less expensive shielding gas, CO₂, and is often amenable to high productivity, giving it economic advantages over spray transfer.

Short-circuit transfer creates welds of high quality, even when using CO₂ shielding gas. In this mode, the filler wire actually touches the base plate, causing a short-circuit in which an amount of metal is transferred to the weld pool. In this case the molten metal experiences little superheating, and less fumes are generated. This mode combines the quality of spray transfer with the economic advantages of globular transfer; however, its productivity is limited by the dynamics of short circuit detachment.

There are two additional undesirable metal transfer modes. One of them, repelled transfer, is common in CO₂ welding. In repelled transfer, the arc is constricted under the droplet, and the reaction force of the plasma (which increases with current) pushes the droplet upwards. The other metal transfer problem observed at high currents is rotational transfer (Lancaster, J. F., The Physics of Welding. 2nd ed. 1986: Pergamon Press. 341) in which a long tail of molten metal rotates.

Experimental studies have determined that spray transfer is achieved at higher currents than globular transfer. It has also been determined that the transition from globular to spray transfer depends strongly on the shielding gas used. Spray transfer is typically considered to require a minimum of 80% argon shielding gas (Cary, H. B., Modern Welding Technology, 2002, Pearson Education, Inc., Upper Saddle River, N.J., p. 116). Rhee (Rhee, S. and E. Kannateyasibu, Analysis of Arc Pressure Effect On Metal Transfer In Gas-Metal Arc-Welding. Journal of Applied Physics, 1991. 70(9): p. 5068-5075; Rhee, S. and E. Kannatey-Asibu, Observation of Metal Transfer during Gas Metal Arc Welding. Welding Journal, 1992: p. 381-386) showed that the addition of helium or CO₂ increases the transition current significantly. For example, Rhee (1991) observed the transition current to be approximately 320 A for a 1.6 mm diameter mild steel wire when a 25% CO₂-75% Ar shielding gas was used, as compared to approximately 280 A in pure argon. For pure CO₂ or helium, spray transfer was not possible even at extraordinarily high welding currents in the range of 1000 A. This is in agreement with the numerical studies of Haidar (Haidar, J., An analysis of the formation of metal droplets in arc welding. Journal of Physics D-Applied Physics, 1998. 31(10): p. 1233-1244) and Lowke (Lowke, J. J., Simple Model for the Transition Current from Globular to Spray Transfer in Gas Metal Arc Welding. Australasian Welding Journal, 1997. 42: p. 32-3). It has also proposed that spray transfer is dependent on the ability of the arc to completely envelop the liquid metal droplet at the end of the melting wire (Rhee 1991, Haidar 1998, Lowke 1997). It has also been suggested that the reason CO₂ and helium do not allow spray transfer is that the size of the anode spot of their plasmas is much smaller than the droplets; their arc is “constricted” in comparison to argon arcs (Rhee, 1991). While “droplet enveloping” is believed necessary for spray transfer, other conditions are also necessary. Dynamic phenomena at the tip of the melting wire must cause droplet detachment. Several mechanisms have been proposed for droplet detachment involving force balances or pinch instability theory (Jones, L. A., T. W. Eagar, and J. H. Lang, A dynamic model of drops detaching from a gas metal arc welding electrode. Journal of Physics D-Applied Physics, 1998. 31(1): p. 107-123; Rhee, 1991)

There remains a need in the art for improved gas metal arc welding processes and apparatus, especially high productivity processes and apparatus capable of producing clean and uniform welds which can use shielding gases having carbon dioxide contents greater than about 30%.

### SUMMARY OF THE INVENTION

The invention provides methods and apparatus for gas metal arc welding (GMAW). The methods and apparatus of the invention allow production of high quality, high productivity welds using less expensive shielding gases than the argon-rich shielding gases currently used in commercial spray transfer systems. A study performed at the Economics and Business Division of Colorado School of Mines (Dickey, S. and G. Brink, The U.S. Welding Market: Target Markets and Consumer Preferences for a Modified Gas Metal Arc Welding Apparatus, in EBGN₅₉₈, M. Heeley, Editor. 2004, Colorado School of Mines: Golden, Colo.) indicated that the expected savings using pure CO₂ for a typical welding operation consuming 700 lb of wire per month and 2,500 cu ft of gas per month are $6,000 per year and machine, with an expected net present value of savings of $50,000 per machine. In addition, the methods of the invention can lead to a reduction in welding fumes as compared to commercial spray transfer systems. The methods and apparatus of the invention can be used for welding all commercially important metals, such as carbon steel, high-strength low alloy steel, stainless steel, aluminum, copper, and nickel alloys. These metals can be welded in all positions if appropriate shielding gases, electrodes, and welding parameters are chosen. In an embodiment, the invention is used for GMAW of steel.

In particular, the methods of the invention allow production of clean and uniform welds at conventional welding current levels under a shielding gas atmosphere having 30% or more carbon dioxide while operating in a metal transfer mode other than short-circuit transfer. In an embodiment, the invention provides a method for achieving spray transfer. Without wishing to be bound by any particular belief, use of smaller electrode wire diameters is believed to facilitate envelopment of the liquid metal droplet at the end of the melting wire by the arc, thus facilitating spray transfer. For a given gas, the current density at the anode (the droplet surface) is believed to be relatively constant. Therefore, the proportion of the drop area covered by the arc can be increased by increasing the welding current or decreasing the wire diameter. The former approach has been studied extensively; the latter has been limited by equipment limitations.

In another embodiment, globular metal transfer occurs but the welding conditions, including the electrode wire diameter, are selected to produce sufficiently small liquid metal drops that welds of acceptable quality are produced. The welding conditions required to obtain the desired metal transfer mode can be obtained through modeling of the welding process, welding experiments, or a combination of modeling and experiments.

In the methods of the invention, the weld quality and productivity is similar to that achieved under typical commercial spray transfer conditions. In the methods of the invention, the metal transfer mode produces sufficiently small drop sizes to result in a clean and uniform weld seam with little spatter and a smooth weld bead.

In an embodiment, the invention provides a gas metal arc welding process comprising the steps of: forming an arc between a consumable metal wire electrode and a workpiece; shielding the arc with a shielding gas having a carbon dioxide content greater than 30%; and feeding the consumable wire electrode through a welding torch contact tip towards the workpiece, the welding torch contact tip electrically contacting the electrode, wherein, during the arc welding process, drops of liquid metal are formed at the electrode and liquid metal is transferred from the electrode to the workpiece, the diameter of the electrode is less than 1.6 mm, the transverse width of the metal drops is less than 2 mm, and transfer of metal from the electrode to the workpiece does not take place by short-circuit transfer.

In another embodiment, the invention provides a gas metal arc welding process comprising the steps of: forming an arc between a consumable metal wire electrode and a workpiece such that the welding current is less than about 500 A; shielding the arc with a shielding gas having a carbon dioxide content greater than about 30%; and feeding the consumable wire electrode through a welding torch contact tip towards said workpiece at a rate greater than about 500 in/min (12.7 m/min), wherein the diameter of said consumable wire electrode is about 0.023 in (0.58 mm) or less.

The invention also provides welding torch contact tips useful for the practice of the invention. In an embodiment, the invention provides a welding torch contact tip assembly for electrically contacting an electrode wire, the contact tip assembly comprising:

a) an electrically insulating body having a longitudinal axis, the electrically insulating body having a first longitudinal bore adapted to allow passage of the electrode wire; and

b) an electrically conducting body having a longitudinal axis, the electrically conducting body comprising a second longitudinal internal bore which contains the electrically insulating body and a contacting surface located downstream of the electrically insulating body and adapted to contact the electrode wire, the length of said contacting surface being less than ten times the wire diameter.

The invention also provides welding torches or guns comprising a contact tip of the present invention in combination with a electrode wire having a diameter less than or equal to 0.58 mm.

The invention also provides a GMAW welding system comprising: a wire feeder capable of feeding a consumable wire electrode having a gauge of about 0.023 in (0.58 mm) or less at a rate greater than about 500 in/min (12.7 m/min); an electrical power supply capable of providing a welding current less than about 1000 A; a gas supply capable of providing a shielding gas having a carbon dioxide content greater than about 30%; and a welding torch, said torch comprising a contact tip assembly of the present invention, said torch adapted to be connected to the wire feeder, the power supply, and the gas supply.

### BRIEF DESCRIPTION OF THE FIGURES

FIG. 1: Schematic showing metal transfer processes and relative advantages.

FIG. 2: Schematic illustrating the liquid metal shape at the tip of the welding electrode during spray transfer.

FIG. 3: Transition current versus carbon dioxide content in the shielding gas for different wire diameters.

FIG. 4A: Schematic longitudinal cross-section of a contact tip assembly before insertion of the electrode wire.

FIG. 4B: Cross-section of the contact tip assembly in FIG. 4A along the dashed line in FIG. 4A.

FIG. 4C: Schematic longitudinal cross-section of the contact tip assembly of FIG. 4A after insertion of the wire.

FIG. 4D: Cross-section of the contact tip assembly in FIG. 4C along the dashed line in FIG. 4C.

FIG. 5: Schematic longitudinal cross-section of a different contact tip assembly after insertion of the wire.

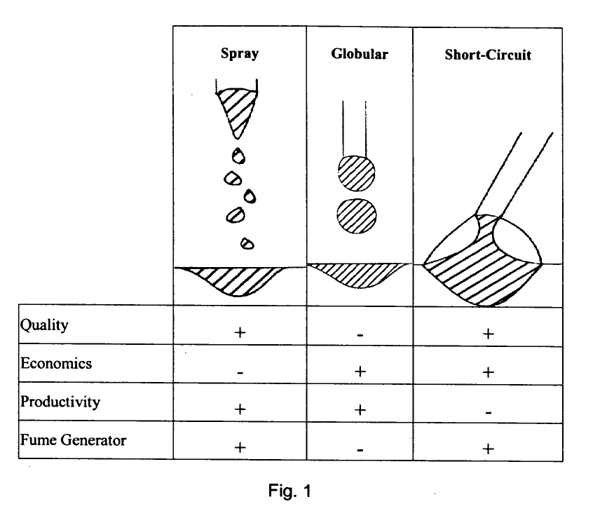

### DETAILED DESCRIPTION OF THE INVENTION

In the methods of the invention, an electric arc is formed between a consumable wire electrode and a workpiece. The electric arc is a sustained electrical discharge through a plasma. The arc can be characterized by the current conducted through the arc, the voltage or potential drop across the arc, and the length of the arc. In gas metal arc welding, the consumable electrode is normally positive and the workpiece negative. In the methods of the invention, the arc generated is a stable arc. As used herein, a stable arc is a continuous arc that does not jump around unexpectedly. In addition, the cathodic and anodic attachment points do not “jump around” or oscillate relative to the contact tip.

The workpiece includes the joint to be welded. During the welding process, the heat of the arc melts the workpiece end of the electrode and drops of molten metal are carried across the arc gap. The heat of the arc also melts a portion of the workpiece, contributing to formation of a weld pool. A substantially uniform arc length is maintained between the melting end of the electrode and the weld pool by feeding the electrode into the arc as fast as it melts.

The shielding gas forms the arc plasma and shields the arc and molten weld pool. The shielding gas is typically supplied to the arc through a gas shielding nozzle which surrounds the contact tip. In different embodiments, the shielding gas composition is at least 30% at least 40%, at least 50% at least 60%, at least 70%, at least 75%, at least 80%, at least 90%, or at least 95% carbon dioxide. In a particular process, the upper limit on the carbon dioxide composition may be less than 100% carbon dioxide. For example, the upper limit may be 60%, 70%, 80%, or 90% carbon dioxide. The balance of the shielding gas may be gases such as argon, helium, oxygen, hydrogen, nitrogen or mixtures thereof. In an embodiment, the balance of the shielding gas is commercially pure argon. In another embodiment, the shielding gas is commercially pure carbon dioxide. Gases suitable for use in GMAW are known to those skilled in the art.

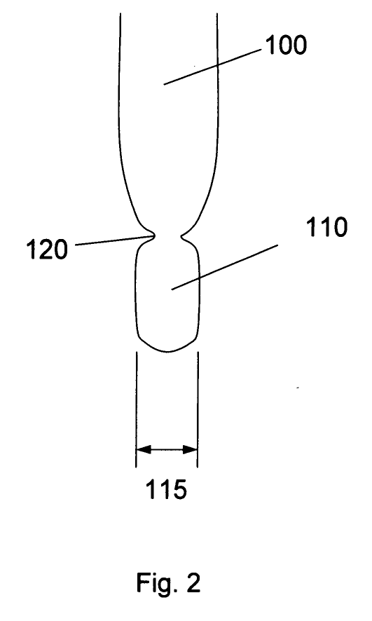

In the methods of the invention, the drops of liquid metal transferred from the electrode to the workpiece are sufficiently small to produce a high quality weld. The size of the drop which reaches the workpiece is related to the size of the liquid metal droplet pendant from the electrode, although the droplet may shrink slightly due to evaporation losses. As used herein, the liquid metal pendant from the electrode is referred to as a drop even if its shape is not generally spherical. FIG. 2 illustrates a non-spherical droplet 110 pendant from electrode 100; the droplet is the liquid metal located below neck 120. FIG. 2 also illustrates the transverse width 115 of the droplet 110. In different embodiments, the transverse width of the pendant drops is less than 2 mm, less than 1.6 mm, less than 1.0 mm, less than 0.75 mm, or less than 0.5 mm.

In globular mode, the liquid metal droplet pendant from the electrode is typically in the form of a generally spherical drop. If the drop shape is generally spherical, the transverse width of the droplet is equivalent to the diameter of the droplet. Globular mode can be defined by the diameter of the droplet being larger than the diameter of the electrode.

Spray mode can be defined as the transverse width of the droplet being smaller than the diameter of the electrode. In spray mode, the tip of the electrode becomes pointed and shape of the liquid metal pendant from the electrode may not be in the form of a spherical drop. The liquid metal pendant from the pointed tip of electrode can take the form of a thin film which surrounds the tip, and a tail which extends from the tip and ends in a droplet. When the liquid metal forms a tail extending from the electrode tip, the droplet is defined as the liquid metal below the neck formed in the tail.

The transverse width of the liquid metal drop pendant from the electrode can be related to the diameter of the electrode. In different embodiments, the transverse width of the drops is less than 1.25 times the diameter of the electrode or less than the diameter of the electrode. In these embodiments, the diameter of the electrode is selected to be sufficiently small to produce sufficiently small drops. In different embodiments, the diameter of the electrode is less than 1.6 mm, less than or equal to 1.0 mm, less than or equal to 0.75 mm, less than or equal to 0.58 mm, less than or equal to 0.45 mm, less than or equal to 0.36 mm or less than or equal to 0.25 mm.

The consumable electrode material may be of any suitable material for the GMAW process of the invention. In an embodiment, the electrode material is selected from the group consisting of iron, iron-carbon alloys, copper, and copper alloys. As used herein, iron-carbon alloys may include other alloying elements and iron-carbon alloys are intended to include steels. In an embodiment, the electrode material is steel. The electrode material may be low-carbon steel, low-alloy steel, medium-carbon steel, or stainless steel. In an embodiment, the electrode material is different in composition from that disclosed in the claims of U.S. Patent Application Publication US2004/0140303. Suitable wire electrode compositions for welding a particular metal are known to those skilled in the art.

Welding power to form the arc is supplied by a power supply connected between the welding torch or gun and the workpiece. The welding torch in turn transfers power to the consumable electrode through the contact tip, which makes electrical contact with the electrode through a contact surface. The consumable electrode is fed through the contact tip. The contact surface may extend the length of the contact tip or may extend over just a portion of the length of the contact tip. In an embodiment, a substantially constant arc voltage is maintained between the wire electrode and the workpiece. In another embodiment, the voltage between the electrode and the workpiece may be pulsed. Any suitable voltage may be used in the invention. In an embodiment, the arc voltage is greater than 15 V. In an embodiment, the arc voltage is between about 15V and about 50V

The welding current is related to the electrode-feed or wire-feed speed. If the electrode extension is constant, at lower currents the relationship between welding current and wire-feed speed (or linear melt-off rate) is typically approximately linear. However, at higher welding currents, particularly with small diameter wires, the relationship between welding current and wire-feed speed tends to become non-linear, so that a change in wire feed speed corresponds to a smaller change in welding current than in the linear region.

The welding current is also related to the electrode extension. If the wire feed speed is constant, increasing the electrode extension typically decreases the current.

The welding current may be constant or pulsed. In different embodiments the welding current is less than 1000 A, less than 500 A, less than 300 A, less than 250 A, less than 200 A, or less than 150 A. However, the welding current is greater than typical short-circuiting transfer welding currents. In an embodiment, the welding current is greater than 100 A.

In different embodiments, the contact tip assembly and/or the wire feeding system are designed for use with electrode diameters of less than about 0.063 inches (1.6 mm), less than or equal to 0.040 inches (1.0 mm), or less than or equal to 0.023 inches (0.58 mm). In an embodiment, the contact tip assembly is designed so that the wire is fed through a conducting tube lined with electrically insulating material prior to making electrical contact with the tip. The insulator-lined tube is sized to prevent buckling of the wire. In an embodiment, the wire feeding system uses a “pull-type” feeder, in which the set of rollers feeds the wire directly into the contact tip. Very thin wires can be difficult to handle with traditional “push-type” feeders, in which a set of rollers push the wire through a long conduit (of the order of 1 m or 40″); the wire is likely to buckle and block the conduit.

In different embodiments, the wire feeding system is capable of feed speeds of greater than about 300 in/min, greater than about 400 in/min, greater than about 500 in/min, greater than about 750 in/min, greater than about 1000 in/min, greater than about 1250 in/min, and greater than about 1500 in/min. Typical wire drives can provide wire feed speeds in the range 70-800 in/min; higher wire feed speed wire drives are available for applications requiring the delivery of wire feed speed up to 1200 in/min (GMAW Welding Guidelines, Lincoln Electric, C4.200 September 2005, p 26, http://content.lincolnelectric.com/pdfs/products/literature/c4200.pdf, accessed Apr. 14, 2006. In an embodiment, the wire feeding system can provide feed speeds greater than those obtainable using commercially available GMAW welding systems.

In an embodiment, the contact tip assembly is designed for use with an electrode extension which is shorter than that typically used with argon-rich shielding gases. As used herein, the electrode extension is the distance between the end of the electrode and the last point of electrical contact between the contact tip and the electrode. The last point of electrical contact is point of electrical contact which is most downstream, or closest to the workpiece (the last point of contact does not necessarily have to be at the closest point of the contact tip to the workpiece). The electrode extension is also known as the electrode stickout. In different embodiments, the electrode extension is less than about one inch (25.4 mm) or less than about one-half inch (12.3 mm). When short electrode extensions are used, the downstream end of the contact tip may be protected from overheating. As used herein, the downstream end of the contact tip is the end nearest the arc. The contact tip can be protected by thermally insulating some or all of the surface of the tip which faces the arc and/or by using an active cooling system. Active cooling systems include, but are not limited to, water cooling or gas cooling of the tip. Gas cooling may be provided by flow of the shielding gas over fins or other structures attached to the contact tip. Any suitable thermal insulation materials known to the art can be used. In an embodiment, the thermal insulation is a highly heat resistant ceramic such as alumina.

In an embodiment, the location of the point of electrical contact is determined with more precision than in current commercial contact tips. A more precise location of the point of electrical contact aids in preventing burnback. In an embodiment, most of the inner surface of the contact tip is electrically insulated from the electrode, with electrical contact between the electrode and the contact tip taking place at a contacting surface located downstream of the electrically insulated portion. In different embodiments, the length of the contacting surface is less than 10 times or less than 5 times the diameter of the electrode wire.

In an embodiment, the electrical contact between the electrode and the contact tip is elastically loaded. Elastic loading of the electrical contact counteracts excessive localized wear which can result from localizing the contact point and high wire feed speeds. Any means of elastic loading known to the art can be used. In one embodiment, elastic loading of the electrical contact may be induced by a set of compliant conducting fingers pressing on the electrode wire. In this embodiment, the contacting surface is located on and provided by the flexible fingers. In another embodiment, elastic loading may be induced by the pressure of slightly bending the electrode wire against a substantially rigid contact element and the substantially rigid element provides the contacting surface.

In an embodiment, flexible conducting elements or “fingers” formed in the downstream end of the electrically conducting body of the contact tip make electrical contact with the electrode. The fingers can be formed by making longitudinal slits in the downstream end of the conducting body, the fingers being the sections of the conducting body between the slits. The width of each slit is less than the diameter of the wire. In this embodiment, the electrically conducting fingers are shaped so that the downstream ends of the fingers extend inwards toward the longitudinal axis of the contact tip, so that the minimum spacing between the fingers along the contact tip diameter in the absence of the electrode wire is less than the diameter of the electrode wire. Consequently, the electrode wire spreads the fingers apart when the wire is initially fed through the contact tip. The electrically conducting contact tip fingers are sufficiently flexible to allow good electrical contact between the contact tip and the electrode wire to be made in this fashion. The contacting surface is at least part of the innermost surface of the fingers. Suitable materials for the conducting body of the contact tip include metals and metal alloys with sufficient electrical conductivity and temperature resistance, including, but not limited to, copper and copper alloys, including alloys of aluminum and copper.

To localize the contact surface, the longitudinal internal bore of the electrically conducting body of the contact tip is larger than the diameter of the electrode wire except in the region where the flexible conducting fingers make electrical contact with the wire. Additionally, the internal bore of the conducting body upstream of this region can be lined with electrically insulating material having a longitudinal internal bore which allows passage of the electrode wire. In different embodiments, the electrically insulating material can be a coating applied to the electrically conducting body or a separate body. If the electrically insulating material is a separate body, the insulating material may be connected to the conducting material via a not too tight pressure fit, as well as by any other means known to those skilled in the art. If the electrically insulating material is located inside of the conducting contact tip fingers, the insulating material does not significantly interfere with the action of the conducting fingers. In an embodiment, the insulating material located inside of the conducting fingers is also formed into fingers, where the fingers formed from the insulating material are sufficiently flexible to allow the conducting fingers to make good electrical contact with the electrode wire. If the insulating material is stiffer than the conducting material, a gap may be provided between the two sets of fingers to allow greater flexibility of the conductive material. Suitable insulating materials include ceramics and polymers. The manufacturing cost of such elastically loaded contact tip is expected to be cheaper than that of contact tip involving moving parts such as springs, pivot points, etc.

In another embodiment for localizing the contacting surface, the contacting surface is located on a substantially rigid element provided downstream of the electrically insulated portion of the conducting body. By substantially rigid, it is meant that the element is more rigid than the electrode wire. At least a portion of the substantially rigid element is located so that it is in the path of the electrode wire exiting the insulated portion of the conducting body, assuring contact between the substantially rigid element and the electrode wire. Since the electrode wire is more flexible than the substantially rigid element, the wire bends slightly, resulting in elastic loading of the electrical contact. In an embodiment, electrode wire is not bent so much that the permanent deformation occurs (the amount of deformation is small enough to remain in the elastic regime). The substantially rigid element may comprise a water cooled channel to protect it from the heat of the arc.

A contact tip assembly with a localized contact surface as described above can be useful to increase quality and service life in welding operations with standard wire diameter and feed speed as well as in the practice of the present invention.

In an embodiment, the methods of the invention allow deposition rates (weight of metal deposited per unit time) and travel speeds comparable to those of conventional GMAW spray transfer processes. In an embodiment, the travel speed is up to about 150 in/min.

The invention also provides a GMAW welding system comprising: a wire feeder capable of feeding a consumable wire electrode having a gauge of about 0.023 in (0.58 mm) or less at a rate greater than about 500 in/min (12.7 m/min); an electrical power supply capable of providing a welding current less than about 1000 A; a gas supply capable of providing a shielding gas having a carbon dioxide content greater than about 30%; and a welding torch, said torch comprising a contact tip assembly of the present invention, said torch adapted to be connected to the wire feeder, the power supply, and the gas supply.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein. When a Markush group or other grouping is used herein, all individual members of the group and all combinations and subcombinations possible of the group are intended to be individually included in the disclosure.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references cited herein are hereby incorporated by reference to the extent that there is no inconsistency with the disclosure of this specification.

In the drawings, like reference labels indicate like elements.

### EXAMPLES

### Example 1

### Calculation of Spray Transfer Conditions in CO₂ with a Mild Steel Electrode

The transition to spray transfer was assumed to correspond to the anode spot just enveloping the drop (the area of the anode spot being equal to the area of the drop minus the cross-sectional area of the wire) as suggested by Rhee and Kannatey-Asibu (Rhee, 1991). The anode current density for CO₂ was assumed to be 3.3×10⁸ A/m² as suggested by Haidar (Haidar 1998). A model based on that of Mendez et al. (Mendez, P. F., N. T. Jenkins, and T. W. Eagar. Effect of Electrode Droplet Size on Evaporation and Fume Generation in GMAW. in Gas Metal Arc Welding for the 21st Century. 2000. Orlando, Fla.: American Welding Society, pp. 325-332, Dec. 6-8, 2000), hereby incorporated by reference, was used to calculate the welding current based on the following processing inputs and material inputs:

Processing inputs:

Electrode feed rate
Electrode extension
Wire diameter

Material inputs:

Solid:

heat diffusivity
density
specific heat
compensation for non-linearities in thermal properties electrical
conductivity at high temperature

Liquid:

density
specific heat
heat conductivity
heat diffusivity
viscosity
marangoni coefficient

Solid-liquid:

melting temperature
heat of melting

Liquid-vapor:

boiling temperature
energy rate of evaporation
evaporative heat transfer exponent

Anode:

current density
voltage of condensation

Other:

droplet diameter
contact tip temperature
permeability of vacuum
turbulent Reynolds number
cone length factor

Division of the welding current by the anode current density allows determination of the anode spot area, and comparison of the anode spot area to the area of the drop.

These calculations predict spray transfer in CO₂ for commercial 0.58 mm (0.023″) mild steel wire at 260 A, an electrode extension of 7 mm (0.28″) and feed rates upward of 1500 in/min.

### Example 2

### GMAW Using Three Different Diameter Steel Wire Electrodes in Atmospheres Ranging from 0-40% CO₂

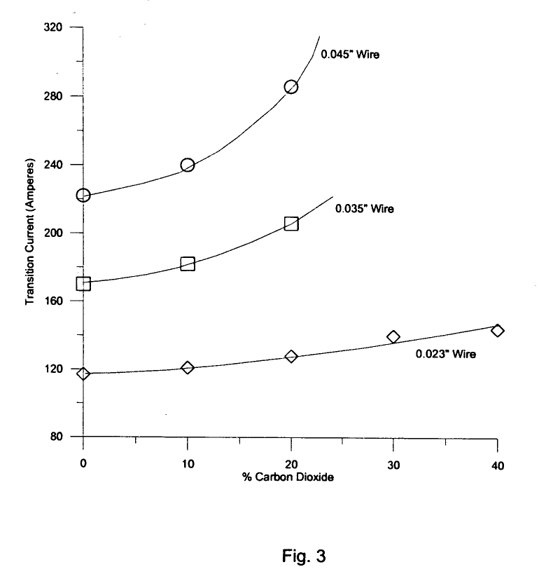

Three different wires were compared in varying atmospheres of CO₂ to investigate changes in transition current from globular to spray; FIG. 3 shows the results. The transition current was determined by Fast Fourier Transform analysis of the current signal. The balance of the shielding gas atmosphere was argon.

FIG. 3 shows that a transition from globular to spray metal transfer was observed for the 0.58 mm wire at both 30 and 40% carbon dioxide atmospheres. The wire feed rates for these conditions were between 800 and 1400 inches per minute.

Further experimental conditions were as follows:

| | |
|---|---|
| Electrode composition: | ER70S-6 |
| Base plate composition: | A36 structural steel |
| Voltage range: | 15-50 Volts |
| Current range: | 15-400 Amperes |
| Electrode Stickout: | 0.25 inches |
| Torch Angle: | 90° to the base plate |
| Travel Speed: | 6-12 inches per minute |
| Contact tip: | Standard |

The wire feeder was a commercially available wire feeder.

### Example 3

### Contact Tip Assembly with Flexible Conducting Fingers

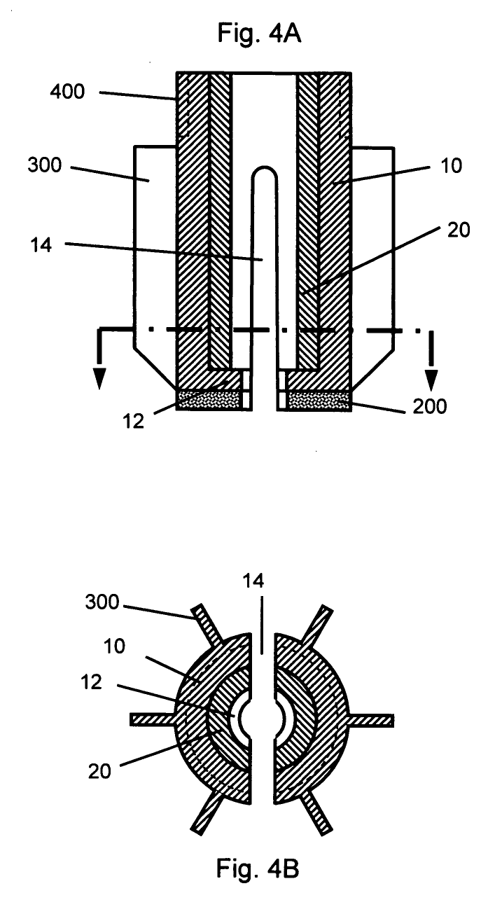

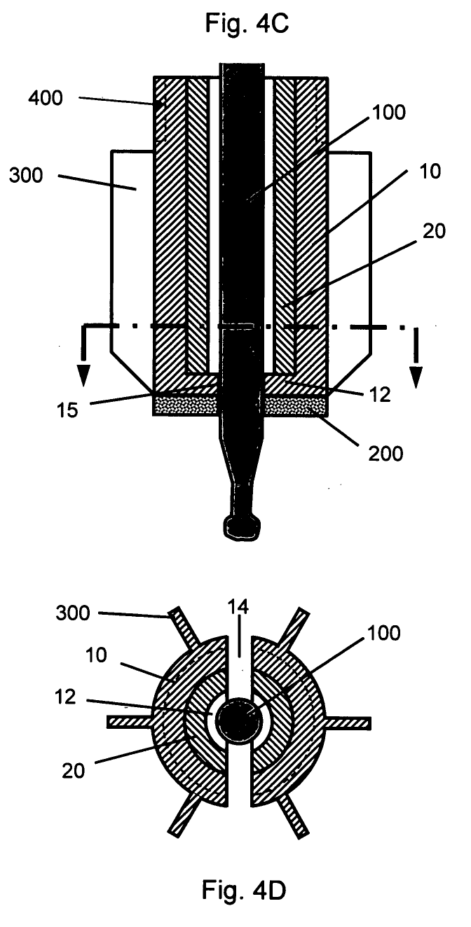

FIGS. 4A-4D illustrate a contact tip assembly suitable for use with the invention. FIG. 4A is a longitudinal cross-section of the contact tip assembly before insertion of the electrode wire (filler wire). FIG. 4B is a cross-section of the contact tip assembly in FIG. 4A along the dashed line in FIG. 4A. FIG. 4C is a longitudinal cross-section of the contact tip assembly after insertion of the wire. FIG. 4D is a cross-section of the contact tip assembly in FIG. 4C along the dashed line in FIG. 4C.

The contact tip assembly comprises an electrically conducting body 10 whose downstream end is formed into flexible conducting fingers 12. The conducting fingers are the sections of the conducting body between longitudinal slits 14 in the downstream end of the conducting body. FIG. 4B shows two conducting fingers being formed, although a greater number of fingers could be formed by additional slits in the conducting body. Electrical contact between the wire 100 and the contact tip is made through contact of the wire by the electrically conductive contact tip fingers along contact surface 15, as shown in FIG. 4C.

As shown in FIGS. 4C-4D, the electrically conducting contact tip fingers project inwards at the downstream end of the contact tip. The contact region of the tip is the length of the tip corresponding to the length of the contacting surfaces. The diameter of the inner bore of the electrically conducting body in the contact region is less than that of the inner bore upstream of the contact region. Comparison of FIGS. 4A and 4C shows that inner bore diameter of the electrically conducting body in the contact region is less than the wire diameter before the wire is inserted and equal to the wire diameter once the wire is inserted.

The inner bore of the electrically conducting body 10 upstream of the contact region is lined with an electrically insulating body 20 which also has an inner bore to allow passage of the electrode wire 100. FIGS. 4B and 4D show slits in the electrically insulating body 20 as well as in the conducting body 10. In addition, FIGS. 4B and 4D show that the inner bore of the conducting body in the contact region is less than that of the inner bore of the insulating body.

As shown in FIGS. 4A and 4C, the contact tip assembly has two layers of thermal protection for the electrically conducting body: one thermally insulating layer 200 for the surface facing the arc, and an active cooling system 300. In FIGS. 4A-4D, active cooling is provided by cooling fins, although other types of cooling features could be used. The cooling fins are in thermal contact with the outer surface of the conducting body at its downstream end.

Label 400 indicates the location of threads which are used to connect the contact tip assembly to the welding torch or gun.

### Example 4

### Contact Tip Assembly with Substantially Rigid Element

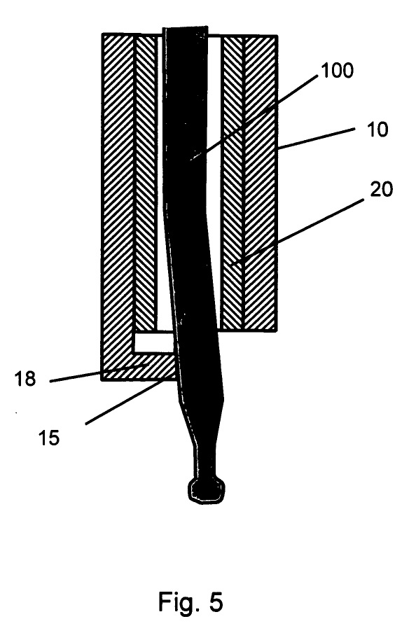

FIG. 5 is a schematic cross-sectional view of a contact tip assembly in which the contacting surface 15 is provided by a substantially rigid element 18 located downstream of the insulated portion of the conducting body. As shown in FIG. 5, element 18 extends both downstream and inwards from the outer portion of the cylindrical portion of the conducting body. In another embodiment, element 18 may also be connected to the downstream end of the cylindrical portion of the conducting body closer to the longitudinal axis of the conducting body. Element 18 projects inwards (towards the longitudinal axis of the conducting body) so that it is located in the path of the electrode wire as it exits the cylindrical portion of the conducting body. As shown, the inner edge of the element does not extend all the way in to the longitudinal axis of the conducting body, but extends further in than the inner diameter of the insulating liner. The electrode wire contacts the inner edge of the element and is bent slightly.

We claim:

1. A gas metal arc welding process comprising the steps of:
a) forming an arc between a consumable metal wire electrode and a workpiece;
b) shielding the arc with a shielding gas having a carbon dioxide content greater than 30%; and
c) feeding the consumable wire electrode through a welding torch contact tip towards the workpiece, the welding torch contact tip having a contacting surface which electrically contacts the electrode,
wherein, during the arc welding process, drops of liquid metal are formed at the electrode and liquid metal is transferred from the electrode to the workpiece, the diameter of the electrode is less than 1.6 mm, the transverse width of the metal drops is less than 2 mm, and transfer of metal from the electrode to the workpiece does not take place by short-circuit transfer.

2. The method of claim 1, wherein the electrode material is selected from the group consisting of iron and iron-carbon alloys.

3. The method of claim 2, wherein the electrode material is steel.

4. The method of claim 1, wherein the diameter of the electrode is less than or equal to 1.0 mm.

5. The method of claim 4, wherein the diameter of the electrode is less than or equal to 0.58 mm.

6. The method of claim 1, wherein the transverse width of the metal drops is less than 1.6 mm.

7. The method of claim 6, wherein the transverse width of the metal drops is less than 1.0 mm.

8. The method of claim 1, wherein the transverse width of the metal drops is less than or equal to the diameter of the electrode.

9. The method of claim 1, wherein the electrode is fed through the contact tip at a rate greater than about 300 in/min.

10. The method of claim 9, wherein the electrode is fed through the contact tip at a rate than about 500 in/min.

11. The method of claim 1, wherein the distance between the workpiece end of the electrode and the contacting surface is less than one inch.

12. The method of claim 1, wherein the distance between the workpiece end of the electrode and the contacting surface is less than one-half inch.

13. The method of claim 1 wherein the carbon dioxide content of the shielding gas is greater than 50%.

14. The method of claim 13, wherein the carbon dioxide content of the shielding gas is greater than 70%.

15. The method of claim 14, wherein the shielding gas is commercially pure carbon dioxide.

16. The method of claim 1, wherein the shielding gas comprises carbon dioxide and argon.

17. A gas metal arc welding process comprising the steps of:
a) forming an arc between a consumable metal wire electrode and a workpiece such that the welding current is less than about 500 A;
b) shielding the arc with a shielding gas having a carbon dioxide content greater than about 30%; and
c) feeding the consumable wire electrode through a welding torch contact tip towards said workpiece at a rate greater than about 500 in/min (12.7 m/min), wherein the diameter of said consumable wire electrode is about 0.023 in (0.58 mm) or less.

18. The process of claim 17, wherein the electrode is fed through the welding torch contact tip at a rate greater than about 750 in/min.

19. The process of claim 18, wherein the electrode is fed through the welding torch contact tip at a rate greater than about 1000 in/min.

20. A welding torch contact tip assembly for electrically contacting an electrode wire, the contact tip assembly comprising:
a) an electrically insulating body having a longitudinal axis, the electrically insulating body having a first longitudinal bore adapted to allow passage of the electrode wire; and
b) an electrically conducting body having a longitudinal axis, the electrically conducting body comprising a second longitudinal internal bore which contains the electrically insulating body and a contacting surface located downstream of the electrically insulating body and adapted to contact the electrode wire, the length of said contacting surface being less than ten times the wire diameter.

21. The contact tip assembly of claim 20, wherein the diameter of the electrode wire is less than or equal to 0.58 mm.

22. The contact tip assembly of claim 20, wherein the contacting surface is located on a substantially rigid electrical conductor.

23. The contact tip assembly of claim 20, wherein the contacting surface is located on a flexible electrical conductor.

24. The contact tip assembly of claim 20, wherein the downstream end of the electrically conducting body is thermally insulated.

25. The contact tip assembly of claim 24, further comprising an active cooling device in thermal contact with the electrically conducting body.

26. A GMAW welding system comprising
a) a wire feeder capable of feeding a consumable wire electrode having a gauge of 0.023 in (0.58 mm) or less at a rate greater than about 500 in/min (12.7 m/min);
b) an electrical power supply capable of providing a welding current less than about 1000 A;
c) a gas supply capable of providing a shielding gas having a carbon dioxide content greater than about 30%; and
d) a welding torch, said torch comprising a contact tip assembly of claim 20, said torch adapted to be connected to the wire feeder, the power supply, and the gas supply.
